(19) United States
(12) Patent Application Publication
(10) Pub. No.: US 2022/0041416 A1
(43) Pub. Date: Feb. 10, 2022

(54) ROBOTIC UNDER-SURFACE LOADER

(71) Applicant: Robert J. Viola, Jackson, WY (US)

(72) Inventor: Robert J. Viola, Jackson, WY (US)

(21) Appl. No.: 17/348,754

(22) Filed: Jun. 15, 2021

Related U.S. Application Data
(60) Provisional application No. 63/062,116, filed on Aug. 6, 2020.

(51) Int. Cl. B66F 9/065; B66F 7/06; B66F 9/075; B60P 1/02

(52) U.S. Cl. CPC B66F 9/065; B66F 7/065; B25J 9/0075; B60P 1/02; B66F 9/0755

(57) ABSTRACT

A robotic under surface loader includes a mobility platform, a parallel manipulator, and a cradle. The mobility platform enables the robotic under surface loader to be moved into place beneath a downwardly facing surface to which a payload is to be attached. The parallel manipulator, which is carried by the mobility platform, carries the cradle, which may in turn carry a payload. The parallel manipulator may position the cradle in six degrees-of-freedom and, thus, precisely position a payload carried by the cradle in a location and an orientation that will facilitate its interaction with (e.g., attachment to, etc.) the downwardly facing surface. Methods for attaching objects, including large, heaving objects, to downwardly facing surfaces are also disclosed.

### CROSS-REFERENCE TO RELATED APPLICATION

A claim to the Aug. 6, 2020 filing date of U.S. Provisional Patent Application No. 63/062,116, titled ROBOTIC UNDER-SURFACE LOADER (“the ‘116 Provisional Application”) is hereby made pursuant to 35 U.S.C. § 119(e). The entire disclosure of the ‘116 Provisional Application is hereby incorporated herein.

### TECHNICAL FIELD

This disclosure relates generally to robotic devices for attaching large, heavy objects to downwardly facing surfaces of structures and, more specifically, to robotic devices that include parallel manipulators to position the large, heavy objects.

### RELATED ART

Attaching large, heavy objects onto the bottom or downward-facing, often generally horizontal surfaces of structures, such as bridges, airplane wings, and other structures is a fundamental industrial operation. Typically, an object must first be wheeled under the structure and then lifted into proximity to the surface of interest. Next, the object must be nominally aligned relative to dedicated attachment features. Finally, the object must be maneuvered into its final position such that it can be secured to these attachment features. This intricate sequence of tasks must be performed with a very high level of precision in order to avoid damaging the object and/or the structure.

The material handling equipment currently used to perform these loading operations utilizes prismatic and/or revolute joints arranged in series. This outdated design template guarantees that positioning an object relative to its attachment features will be a slow, tedious process, as the arrangement of joints in series limits movement of an object to be loaded or positioned around a single point in space.

### SUMMARY

A fundamentally new approach to aligning and attaching objects to the bottom, downwardly facing, generally horizontal surfaces of structures comprises a robotic under-surface loader that employs a parallel manipulator, which can orient its payload, which is also referred to herein more generally as an object, relative to a plurality of different points in space. The parallel manipulator may comprise a six-axis parallel manipulator, which may provide control over an object's position in all six degrees-of-freedom. Parallel manipulators are also inherently much stiffer than serial manipulators allowing an object to be positioned more easily and with greater accuracy.

A robotic under-surface loader according to this disclosure may include a mobility platform, the parallel manipulator, and a cradle. In some embodiments, the robotic under-surface loader may also include a vertical lift.

The mobility platform may enable movement of the robotic under-surface loader from one location to another location. For example, the mobility platform may stage the robotic under-surface loader and an object carried thereby in a nominally correct location under a structure. More specifically, the mobility platform may stage the robotic under-surface loader and an object carried thereby, beneath a downwardly facing surface, or surface of interest, of the structure, relative to which the object is to be positioned. The mobility platform may comprise a vehicle. The vehicle may comprise a powered vehicle. Alternatively, the vehicle may comprise a cart that may be positioned manually and/or by way of a powered vehicle.

The parallel manipulator may comprise a dexterous, motor-driven “robot” that performs the fine positioning of the object relative to the surface of interest. The parallel manipulator may enable selection of a point in space about which the object is to be located/oriented. The parallel manipulator may also enable the selection of one or more other points in space for further location and/or orientation of the object. Thus, the parallel manipulator may enable adjustment of a location and/or an orientation of the object about, or relative to, a plurality of fixed points in space. The parallel manipulator may be a conventional industrial hexapod. Alternatively, the parallel manipulator may be a low-profile parallel manipulator, such as a so-called “Tri-Sphere” parallel manipulator, which may also be referred to as a “Tri-Sphere robot” or, more simply, as a “Tri-Sphere.”

The cradle of the robotic under-surface loader serves as the physical interface between the robotic under-surface loader and the object the robotic under-surface loader carries. This cradle may, therefore, be tailored to carry a specific type of object. The cradle may be actively powered or it may be passive.

In some embodiments, including but not limited to those embodiments where the vertical travel of the parallel manipulator is limited, the robotic under-surface loader may include a vertical lift. The vertical lift may enhance the extent to which the robotic under-surface loader may lift the object it carries, thereby extending the work envelope of the robotic under-surface loader when additional travel is needed to reach the surface of interest. The vertical lift may comprise a high-payload lifting device, such as a vertical lift (i.e., a long stroke lift or scissor-lift), a hydraulic elevator, or the like.

In another aspect, this disclosure relates to methods positioning objects beneath structures. Such a method may include placing an object on a cradle of an robotic under-surface loader, moving the robotic under-surface loader into position beneath a downwardly facing surface of the structure, using a parallel manipulator to position the object in a proper location and/or orientation relative to the downwardly facing surface, and securing the object in place relative to the downwardly facing surface. In some embodiments, such a method may also include vertically lifting the object toward, or in proximity to, the downwardly facing surface.

Positioning of the object with the parallel manipulator may include defining a first point in space about, or around, which the object is to be oriented, orienting the object around the first point in space. Thereafter, a second point in space about, or around, which the object is to be oriented may be selected and the object may be oriented around the second point in space. Such movement may be useful in situations where the object is to be secured at a plurality of connection points, which may significantly reduce the duration of time required to position and place an object relative to the duration of time required by conventional loaders that employ series of joints to move an object about a single fixed point in space.

The robotic under-loader may serve as a powerful enabling technology supporting a range of industrial and military operations. It is well suited for installing large concrete panels onto tunnel ceilings and for fitting girders and other structural elements into place during bridge construction. Aviation maintenance crews can use it to remove and re-install large jet engines from commercial aircraft. The United States Air Force (USAF) and other service branches have an acute need for new technologies capable of efficiently loading munitions, fuel pods and other mission equipment onto military aircraft. Collectively, these applications represent a potent and enduring market for the robotic under-surface loader.

Other aspects of the disclosed subject matter, as well as features and advantages of various aspects of the disclosed subject matter, should be apparent to those of ordinary skill in the art through consideration of the preceding disclosure, the accompanying drawings, and the appended claims

### BRIEF DESCRIPTION OF THE DRAWINGS

In the drawings:

FIG. 1 is a side view of an embodiment of a robotic under surface loader according to this disclosure, showing a cradle of the robotic under surface loader in a lowered position;

FIG. 2 is a side view of the embodiment of robotic under surface loader shown in FIG. 1, with a lift of the robotic under surface loader placing a parallel manipulator of the robotic under surface loader in a raised position and the parallel manipulator placing the cradle in a raised position;

FIG. 3 is a perspective view of the embodiment of robotic under surface loader shown in FIG. 1, with the cradle in the raised position;

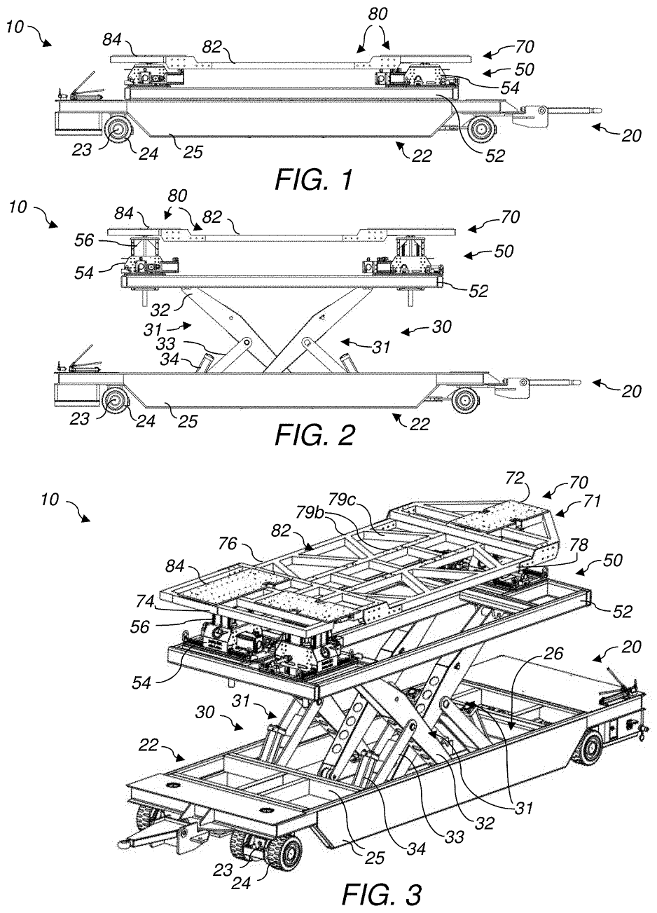

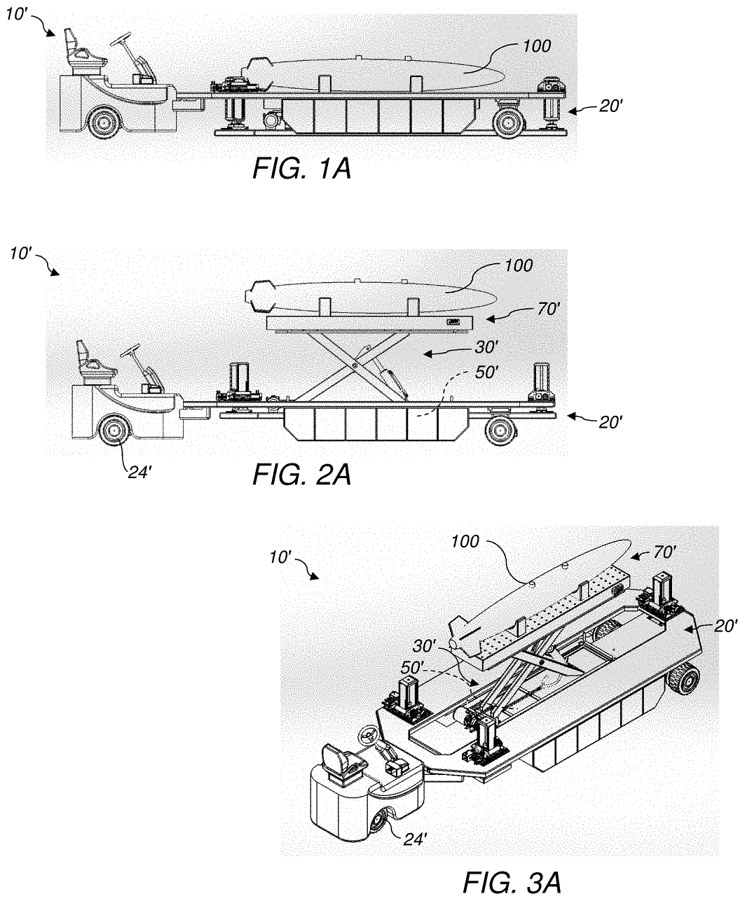

FIG. 1A is a side view of another embodiment of a robotic under surface loader according to this disclosure, showing a cradle of the robotic under surface loader in a lowered position;

FIG. 2A is a side view of the embodiment of robotic under surface loader shown in FIG. 1A, with a lift of the robotic under surface loader placing a parallel manipulator of the robotic under surface loader in a raised position and the parallel manipulator placing the cradle in a raised position;

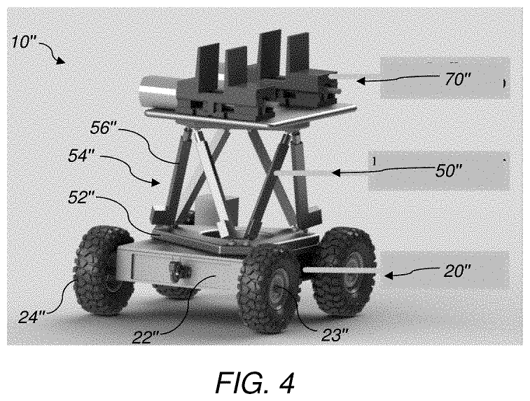

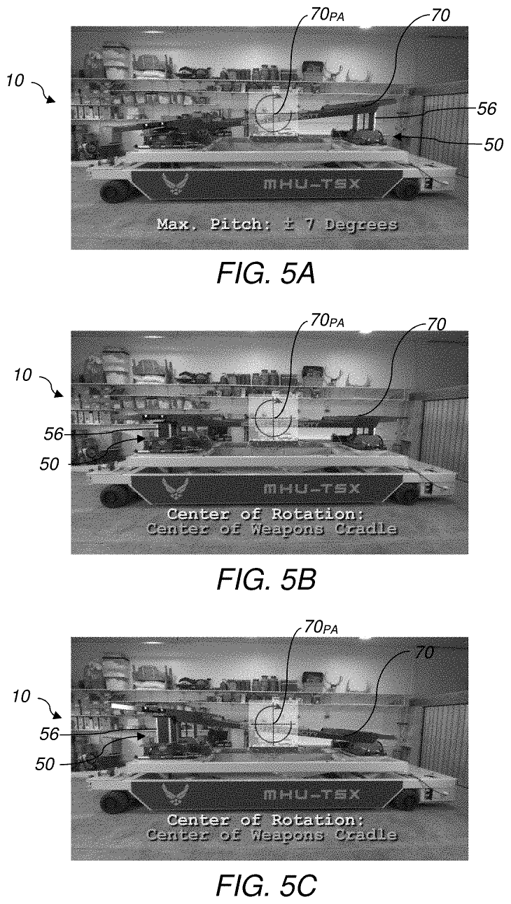

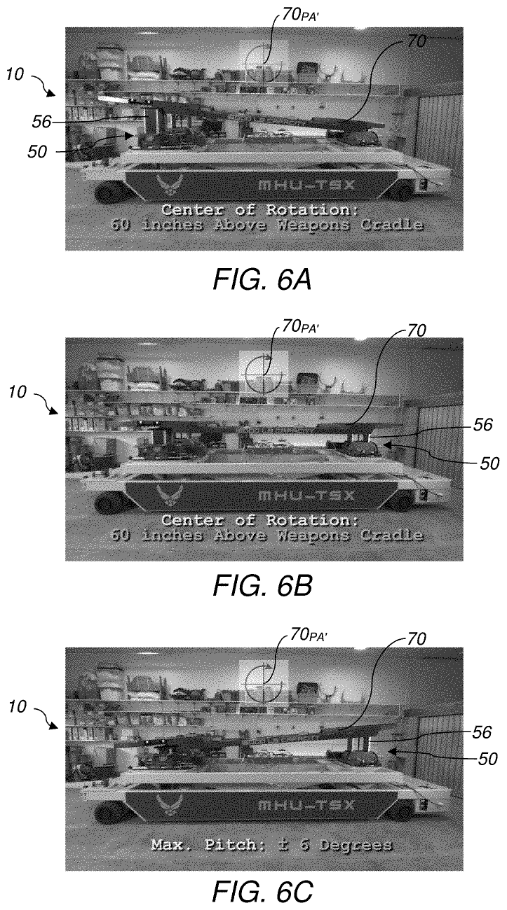

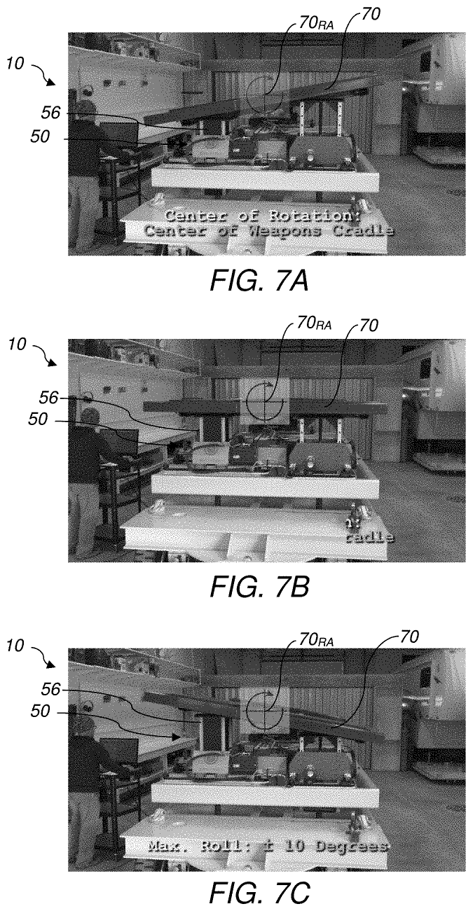

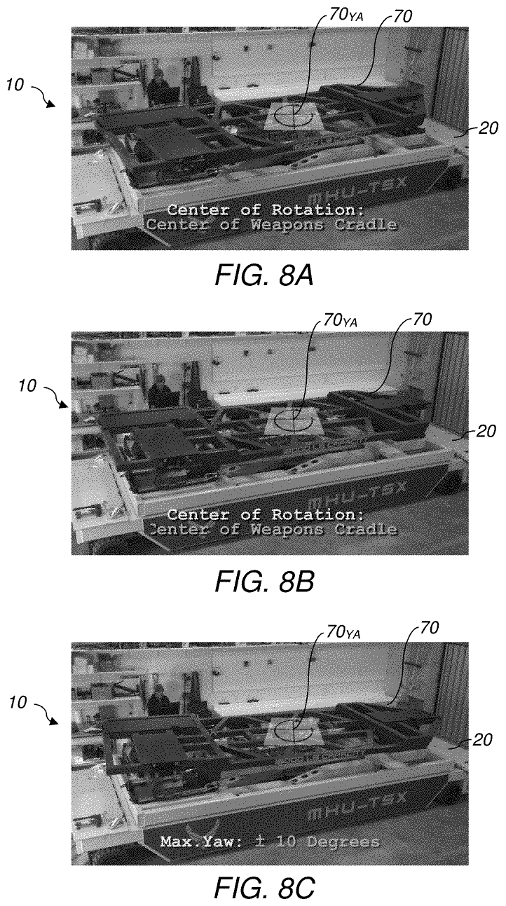

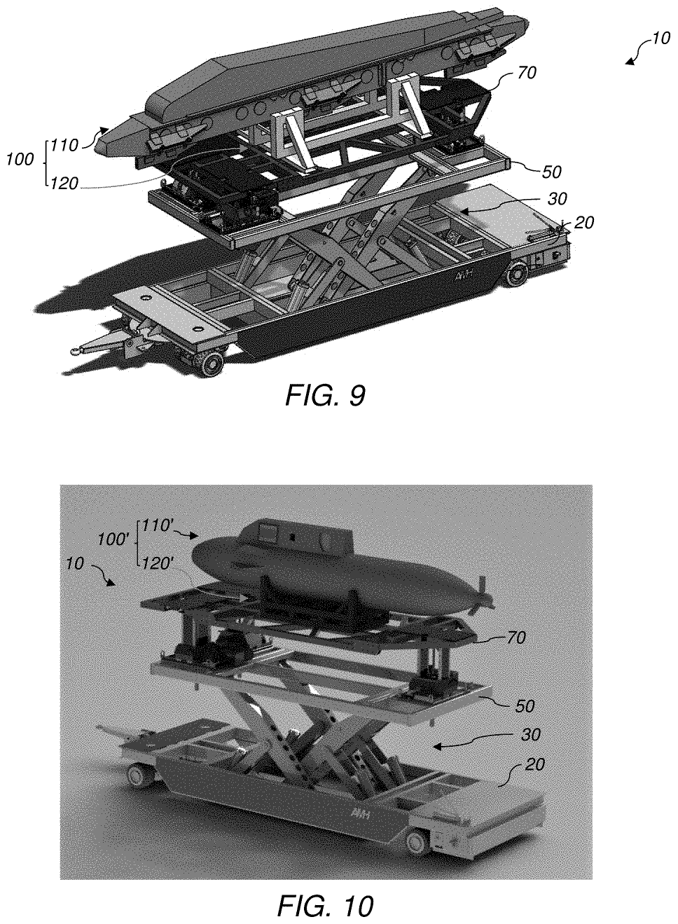

FIG. 3A is a perspective view of the embodiment of robotic under surface loader shown in FIG. 1A, with the cradle in the raised position;

FIG. 4 is a perspective view of yet another embodiment of robotic under surface loader according to this disclosure;

FIGS. 5A-5C depict end-to-end rotational movement, or pitch, of the cradle about a latitudinal axis of the cradle of the embodiment of robotic under surface loader shown in FIGS. 1, 2, and 3;

FIGS. 6A-6C depict end-to-end rotational movement, or pitch, of the cradle about an axis positioned 60 inches above the latitudinal axis of the cradle of the embodiment of robotic under surface loader shown in FIGS. 1, 2, and 3;

FIGS. 7A-7C depict side-to-side rotational movement, or roll, of the cradle about a longitudinal axis of the cradle of the embodiment of robotic under surface loader shown in FIGS. 1, 2, and 3;

FIGS. 8A-8C depict rotational movement, or yaw, of the cradle about center of the cradle, or a point at which the latitudinal axis and the longitudinal axis of the cradle intersect of the embodiment of robotic under surface loader shown in FIGS. 1, 2, and 3;

FIG. 9 shows the embodiment of robotic under surface loader of FIGS. 1, 2, and 3 carrying a first type of payload and a first type of cradle corresponding to the first type of payload; and

FIG. 10 shows the embodiment of robotic under surface loader of FIGS. 1, 2, and 3 carrying a second type of payload and a second type of cradle corresponding to the second type of payload.

### DETAILED DESCRIPTION

FIGS. 1-3 illustrate an embodiment of a robotic under surface loader 10 according to this disclosure. The robotic under surface loader 10 may also be referred to herein as an “under surface loader” or as a “loader.” The robotic under surface loader 10 may include a mobility platform 20, a parallel manipulator 50, and a cradle 70. The mobility platform 20 may carry the parallel manipulator 50. The parallel manipulator 50 may carry the cradle 70. In some embodiments, the robotic under surface loader 10 may also include a lift 30. The lift 30 may be disposed between the mobility platform 20 and the parallel manipulator 50, as illustrated. Alternatively, as shown in FIGS. 2A and 3A, a robotic under surface loader 10′ may include a lift 30′ disposed between the parallel manipulator 50′ and the cradle 70′ of the robotic under surface loader 10′.

FIG. 1 shows the cradle 70 of the robotic under surface loader 10 in a completely lowered position. When the cradle 70 is completely lowered, the lift 30 is lowered and collapsed into the mobility platform 20. The parallel manipulator 50 is also lowered.

FIGS. 2 and 3 show the cradle 70 of the robotic under surface loader 10 in a completely raised position. When the cradle 70 is completely raised, the lift 30 is raised and extends from the mobility platform 20. The parallel manipulator 50 is also raised.

The mobility platform 20 may include a chassis 22, axles 23, and wheels 24. The axles 23 may be secured to the chassis 22 and the wheels 24 may be secured to the axles 23 in a manner that enables the wheels 24 to rotate. In addition, the mobility platform 20 may include any of a variety of other components, including a suspension, steering, one or more jack stands, a towing tongue, and the like. The mobility platform 20 may comprise a passive device (e.g., it may be manually moveable, towable, etc.), as shown in FIGS. 1, 2, and 3. Alternatively, as shown in FIGS. 1A, 2A, and 3A, a robotic under surface loader 10′ may include a mobility platform 20′ that comprises an active device (e.g., it may include one or more motors, an engine and drivetrain, etc., that drive movement of one or more of the wheels 24′).

With returned reference to FIGS. 1, 2, and 3, the chassis 22 of the mobility platform 20 may also carry other components of the robotic under surface loader 10. In some embodiments, a frame 25 of the chassis 22 may define a receptacle 26 that may at least partially receive and, thus, laterally surround one or more other components of the robotic under surface loader 10. As an example, as can be seen by comparing FIGS. 1 and 2, when the illustrated embodiment of lift 30 of the robotic under surface loader 10 is lowered, it may collapse into and be received by the receptacle 26 defined by the frame 25 of the chassis 22. Thus, the chassis 22 may laterally surround substantially all of the lift 30. As used in this context, the term “substantially” is used to accommodate features of the lift 30 that may extend beyond the upper extent of the chassis 20 while the lift 30 is in its lowered arrangement, such as features (e.g., hinges, etc.) that couple the lift 30 to the parallel manipulator 50.

The optional lift 30 may comprise any suitable lift known in the art. Without limitation, as shown in FIGS. 2 and 3, the lift 30 may comprise a vertical lift of a type known in the art, which is also known as a long stroke lift or as a “scissor lift.” As illustrated, the robotic under surface loader 10 may include two lifts 30. Each lift 30 may include two scissor pairs 31 and at least one lift cylinder 34 (e.g., a hydraulic lift cylinder, etc.). Each scissor pair 31 may include pivotally interconnected scissor legs 32 and 33.

In a specific embodiment, the lift 30 may lift a payload (not including the weight of the parallel manipulator 50 or the cradle 70) of up to about 16,000 lbs. (about 7,250 kg) or more. Of course, lifts 30 with other capacities are also within the scope of this disclosure. In a specific, non-limiting embodiment, the lift 30 may raise the parallel manipulator 50 by as much as about 82 inches (about 2.2 m) or more at a rate of about 3 in./s (about 7.6 cm/s).

Operation of the lift 30 may occur in any suitable manner known in the art.

The lift 30 may, as illustrated by FIGS. 2 and 3, carry the parallel manipulator 50. Alternatively, the parallel manipulator may be carried directly by the mobility platform 20 and may, in turn, carry any optional lift 30.

The parallel manipulator 50 may comprise a suitable parallel manipulator of a type known in the art. The parallel manipulator 50 may comprise a six-axis parallel manipulator, which may position the cradle 70 precisely and accurately in all six degrees-of-freedom. As an example, the parallel manipulator 50 may comprise a Tri-Sphere kinematic positioning system, or “Tri-Sphere robot,” of the type described by U.S. Pat. No. 7,849,762 B2 to Robert J. Viola, the entire disclosure of which is hereby incorporated herein. Such a parallel manipulator may accommodate a payload of up to 60,000 lbs. (about 27,200 kg). Of course, parallel manipulators 50 with other capacities are also within the scope of this disclosure.

In any embodiment, the parallel manipulator 50 includes a base 52, a plurality of manipulators 54 supported by the base 52, a manipulator arm 56 of each manipulator 54. The manipulator arms 56 may support and position the cradle 70. In addition, the parallel manipulator 50 may include a processor (not shown) that controls the operation of each manipulator 54 and the movement each manipulator arm 56, as well as coordinated operation of the manipulators 54 and coordinated movement of the manipulator arms 56 to place the cradle 70 and a payload assembly 100 (not shown in FIG. 1, 2, or 3; see FIGS. 1A, 2A, and 3A) carried by the cradle 70 in a desired location and/or orientation.

In a specific embodiment, each manipulator 54 of the parallel manipulator 50 may lift its corresponding manipulator arm 56 by a distance of about 22 inches (about 56 cm). Each manipulator 54 may raise and/or lower its corresponding manipulator arm 56 at a rate of about two inches per second (2 in./s; about 5.1 cm/s).

In the illustrated embodiment, the cradle 70 is carried by the manipulator arms 56 of the manipulators 54 of the parallel manipulator 50. Alternatively, the cradle 70 may be carried by an optional lift 30, which may in turn be carried by the manipulator arms 56 of the manipulators 54 of the parallel manipulator 50.

The cradle 70 has a configuration and dimensions that impart it with a particular payload capacity, or maximum payload. As illustrated, the cradle 70 includes a frame 71 with two ends 72 and 74. The ends 72 and 74 may be opposite from one another. A first end 72 may comprise a fore end, or forward end, of the cradle 70. A second end 74 may comprise an aft end, or rear end, of the cradle 70. In addition to the ends 72 and 74, the frame 71 of the cradle 70 may include two sides 76 and 78. Each side may extend between the first end 72 and the second end 74. The sides 76 and 78 may be opposite from one another. The frame 71 may also include various members 79, such as longitudinal beams 79b and cross members 79c, that are configured and arranged in a manner that imparts the cradle 70 with a particular payload capacity.

The cradle 70 may also include an upper surface 80 that receives a payload. The upper surface 80 may reside substantially within a single plane or, as illustrated by FIGS. 1-3, it may include one or more recessed portions 82 and/or one or more raised portions 84, which may have shapes and/or dimensions that enable the upper surface 80 to receive and, optionally, retain payloads with specific shapes. The upper surface 80 may include other features, which features may facilitate positioning of a payload on the upper surface 80 (e.g., align the payload with the upper surface 80, etc.), prevent movement of a payload once it has been placed on the upper surface 80, secure a payload to the cradle 70, protect a payload and/or the cradle 70, or otherwise enable the cradle 70 and its upper surface 80 to interact with a payload in a desired manner.

In embodiments such as that depicted by FIGS. 1-3, the relative positions of the features of the upper surface 80 of the cradle 70 are fixed. Alternatively, as shown and described below in reference to FIG. 4, the cradle 70 may include one or more adjustable features.

FIG. 4 depicts another embodiment of robotic under surface loader 10″. The robotic under surface loader 10″ includes a mobility platform 20″, a parallel manipulator 50″, and a cradle 70″. The embodiment of robotic under surface loader 10″ depicted by FIG. 4 lacks a lift; however, robotic under surface loaders that include features such as those depicted by FIG. 4 may also include a lift that carries the parallel manipulator 50″ (i.e., is located beneath the parallel manipulator 50″) or is carried by the parallel manipulator 50″ (i.e., is located over the parallel manipulator 50″ and, in turn, carries the cradle 70″).

The mobility platform 20″ of the robotic under surface loader 10″ may include a chassis 22″, axles 23″, and wheels 24″. The axles 23″ may be secured to the chassis 22″ and the wheels 24″ may be secured to the axles 23″ in a manner that enables the wheels 24″ to rotate. In addition, the mobility platform 20″ may include any of a variety of other components, including a suspension, steering, one or more jack stands, a towing tongue, and the like. The mobility platform 20″ may comprise a passive device (e.g., it may be manually moveable, towable, etc.) or it may comprise an active device (e.g., it may include one or more motors, an engine and drivetrain, etc., that drive movement of one or more of the wheels 24″).

The parallel manipulator 50″ of the robotic under surface loader 10″ may comprise a hexapod of a type known in the art. The hexapod may be carried by a base 52″ of the parallel manipulator 50″. In some embodiments, the hexapod may rotate relative to the base 52″. The hexapod may include six manipulators 54″, each of which includes a manipulator arm 56″. Each manipulator 54″ may be independently operated to position its manipulator arm 56″ in such a way that all of the manipulators 54″ and their manipulator arms 56″ will position the cradle 70″ in any of a variety of locations and/or orientations.

The cradle 70″ may be adjustable. The optional adjustability of the cradle 70″ may enable the cradle 70″ to assume any of a variety of different configurations, which may enable the cradle 70″ to receive payloads of any of a variety of different configurations and/or dimensions. The optional adjustability of the cradle 70″ may enable the cradle 70″ to facilitate alignment of payloads therewith, retention of payloads, securing of payloads, or otherwise enable the cradle 70″ to interact with a payload in a desired manner.

An adjustable cradle 70″ may be actively powered. Thus, it may include one or more motors that may enable the selective and automated movement of one or more adjustable features of the cradle 70″.

With reference now turned to FIGS. 5A-8C, use of the parallel manipulator 50 to orient the cradle 70 and any payload assembly 100 (FIGS. 1A, 2A, 3A, and 4) thereon is depicted. While FIGS. 5A-8C illustrate an embodiment of robotic under surface loader 10 that includes a parallel manipulator 50 comprising a Tri-Sphere robot and a passive cradle 70, it should be understood that the subject matter depicted by and described with reference to FIGS. 5A-8C is also applicable to robotic under surface loaders with other embodiments of parallel manipulators and cradles.

FIGS. 5A-5C depict use of the parallel manipulator 50 to effect end-to-end rotational movement, or pitch, of the cradle 70 about a latitudinal axis, or a pitch axis 70_{PA}, of the cradle 70. FIG. 5B shows an initial arrangement of the parallel manipulator 50 and an initial position of the cradle 70, in which the manipulator arms 56 of the parallel manipulator 50 are extended to intermediate positions (e.g., half the maximum distance each manipulator arm 56 may be raised, another portion of the maximum distance each manipulator arm 56 may be raised, etc.) and, thus, the manipulator arms 56 raise the cradle 70 to an intermediate position relative to the lift 30. FIG. 5A shows the cradle 70 tilted in a fore (forward) direction. FIG. 5B shows the cradle 70 positioned horizontally, with no tilt, or in a neutral pitch relative to the pitch axis 70_{PA}. FIG. 5C shows the cradle 70 tilted in an aft (rearward) direction. In a specific, non-limiting embodiment, the parallel manipulator 50 may tilt each end 72, 74 of the cradle 70 about the pitch axis 70_{PA} a distance of about ±11 inches (about ±28 cm) for a maximum pitch of about ±7°.

FIGS. 6A-6C depict use of the parallel manipulator 50 to effect end-to-end rotational movement, or pitch, of the cradle 70 about an elevated pitch axis 70_{PA}′ positioned 60 inches above the pitch axis 70_{PA} of the cradle 70. FIG. 6B shows an initial arrangement of the parallel manipulator 50 and an initial position of the cradle 70, in which the manipulator arms 56 of the parallel manipulator 50 are extended to intermediate positions and, thus, the manipulator arms 56 raise the cradle 70 to an intermediate position relative to the lift 30. FIG. 6A shows the cradle 70 tilted in the fore direction. FIG. 6B shows the cradle 70 positioned horizontally. FIG. 6C shows the cradle 70 tilted in the aft direction. In a specific, non-limiting embodiment, the parallel manipulator 50 may tilt each end 72, 74 of the cradle 70 about the elevated pitch axis 70_{PA}′ a distance of about ±11 inches (about ±28 cm) for a maximum pitch of about ±6°.

FIGS. 7A-7C depict use of the parallel manipulator 50 to effect side-to-side rotational movement, or roll, of the cradle 70 about a longitudinal axis, or a roll axis 70_{R}A, of the cradle 70. FIG. 7B shows an initial arrangement of the parallel manipulator 50 and an initial position of the cradle 70, in which the manipulator arms 56 of the parallel manipulator 50 are extended to intermediate positions and, thus, the manipulator arms 56 raise the cradle 70 to an intermediate position relative to the lift 30. FIG. 7A shows the cradle 70 tilted to one side 76. FIG. 7B shows the cradle 70 positioned horizontally. FIG. 7C shows the cradle 70 tilted to the other side 78. In a specific embodiment, the parallel manipulator 50 may tilt each side 76, 78 of the cradle 70 about the roll axis 70_{RA} a distance of about ±11 inches (about ±28 cm) for a maximum roll of about ±10°.

FIGS. 8A-8C depict use of the parallel manipulator 50 to effect rotational movement, or yaw, of the cradle 70 about a center, or a yaw axis 70_{YA} of the cradle 70. The yaw axis 70_{YA} is located at a point at which the pitch axis 70_{PA} (FIGS. 5A-5C) and the roll axis 70_{RA} (FIGS. 7A-7C) of the cradle 70 intersect. FIG. 8B shows an initial arrangement of the parallel manipulator 50 (FIGS. 1-3) and an initial position of the cradle 70 relative to the mobility platform 20 of the robotic under surface loader 10, in which the cradle 70 is not rotated relative to the mobility platform 20 (i.e., yaw=0°). FIG. 8A shows the cradle 70 rotated in a counterclockwise direction relative to the mobility platform 20. FIG. 8B shows the cradle 70 unrotated relative to the mobility platform 20. FIG. 8C shows the cradle 70 rotated in a clockwise direction relative to the mobility platform 20. In a specific, non-limiting embodiment, the parallel manipulator 50 may rotate the cradle 70 about the yaw axis 70_{YA} about ±10°, thus providing the cradle 70 with a yaw of about ±10°.

As demonstrated by FIGS. 5A-8C, the combined movements (X, Y, Z, pitch, roll, yaw) of the parallel manipulator 50 may position the cradle 70 and its payload in all six degrees-of-freedom, enabling the cradle 70 and its payload to be placed in a wide variety of locations and orientations that are limited only by the lengths of travel of the manipulator arms 56 of the manipulators 54 of the parallel manipulator 50. Thus, the parallel manipulator 50 may enable the cradle 70 and a payload carried by the cradle 70 to be precisely and accurately positioned beneath a downwardly facing surface.

In specific embodiments, a robotic under surface loader 10 according to this disclosure may be used to lift heavy objects to the undersides of the wings of aircraft. FIG. 9 shows a robotic under surface loader 10 carrying an under-wing mounting pylon 110 for a Boeing B-52 aircraft. The under-wing mounting pylon 110 is carried by a load tray 120 that has been design specifically for use with the under-wing mounting pylon 110. The load tray 120 includes a base 122 that can be supported and stably carried by the cradle 70 of a robotic under surface loader 10 and an upper portion 124 that receives and enables the load tray 120 to support and stably carry the under-wing mounting pylon 110. Together, the under-wing mounting pylon 110 and the load tray 120 form a payload assembly 100.

FIG. 10 shows a robotic under surface loader 10 carrying a wing-tip aerial refueling pod 110′ for a Boeing KC-46 aircraft. The wing-tip aerial refueling pod 110′ is carried by a load tray 120′ that has been designed specifically for use with the wing-tip aerial refueling pod 110′. A base 122′ of the load tray 120′ may be supported and stably carried by the cradle 70 of a robotic under surface loader 10. A top portion 124′ of the load tray 120′ may support and stably carry the wing-tip aerial refueling pod 110′. When assembled, the wing-tip aerial refueling pod 110′ and its load tray 120′ define a payload assembly 110′.

Similarly, a robotic under surface loader 10 may be used to place munitions beneath the wings of aircraft so the munitions may be safely (i.e., without unintended movement or drops) and readily mounted to the wings of the aircraft.

As illustrated by FIGS. 9 and 10, the mobility platform 20 may be used to place the robotic under surface loader 10 and its payload assembly 100, 100′ beneath a downwardly facing surface to which the payload carried by the cradle 70 (e.g., the under-wing mounting pylon 110, the wing-tip aerial fueling pod 110′, etc.) is to be mounted or otherwise associated (e.g., the underside of an aircraft wing, etc.). A lift 30, if any, and/or the parallel manipulator 50 of the robotic under surface loader 10 may lift the cradle 70 and the payload assembly 100, 100′ in proximity to the downwardly facing surface. The parallel manipulator 50 may adjust a location and/or an orientation of the cradle 70 and the payload assembly 100, 100′ to position the payload so that it may be readily mounted to or otherwise associated with the downwardly facing surface. The parallel manipulator 50 may orient the payload in such a way that minimal or no further adjustment to the location and/or orientation of the payload is needed to mount or otherwise associate the payload with the downwardly facing surface. In some embodiments, the lift 30, if any, and/or the parallel manipulator 50 may lift the payload further to enable the payload to be mounted or otherwise associated with the downwardly facing surface. With the payload oriented and positioned beneath the downwardly facing surface, it may be mounted to or otherwise associated with the downwardly facing surface. By precisely positioning the payload, the robotic under surface loader 10 may stably support the payload throughout the positioning and mounting/association process.

A robotic under surface loader 10 according to this disclosure may also be used to facilitate the removal of an object (i.e., the payload) from a downwardly facing surface. A load tray 120, 120′, if any, that corresponds to the object may be placed on the cradle 70 of the robotic under surface loader 10. The robotic under surface loader 10 may then be moved, by way of the mobility platform, into position beneath the object, with the cradle 70 and any load tray 120, 120′ thereon also being positioned beneath the object. With the cradle 70 and any load tray 120, 120′ in place, they may be lifted and oriented so as to be stably positioned against the object. With the cradle 70 and any load tray 120, 120′ in place against the object, the object may be removed from the downwardly facing surface. The object, any load tray 120, 120′, and the cradle 70 may then be lowered, and the mobility platform 20 may be used to transport the object to a desired location.

While the above-described methods refer to the placement of objects against and the removal of objects from beneath the wings of aircraft, a robotic under surface loader 10 of this disclosure may be used to position any of a variety of other objects adjacent to or against any of a variety of downwardly facing surfaces. For example, a robotic under surface loader may be used to lift large concrete panels onto the ceilings of tunnels, girders and other structural elements into place during bridge construction, and in a variety of other applications.

Although this disclosure provides many specifics, the specifics should not be construed as limiting the scope of any appended claim, but merely as providing information pertinent to some specific embodiments that may fall within the scopes of the appended claims. Features from different embodiments may be employed in combination. In addition, the scope of each appended claim may encompass other, undisclosed embodiments. All additions to, deletions from, and modifications of the disclosed subject matter that fall within the scopes of the claims are to be embraced by the claims.

What is claimed:

1. A robotic under-surface loader, comprising:
a mobility platform;
a parallel manipulator carried by the mobility platform; and
a cradle for an object to be positioned beneath a structure, the parallel manipulator controlling a location and/or an orientation of the cradle and the object carried by the cradle.

2. The robotic under-surface loader of claim 1, wherein the mobility platform comprises a powered vehicle.

3. The robotic under-surface loader of claim 1, wherein the mobility platform comprises a passive vehicle.

4. The robotic under-surface loader of claim 1, wherein the parallel manipulator can control six degrees-of-freedom.

5. The robotic under-surface loader of claim 4, wherein the parallel manipulator comprises a hexapod.

6. The robotic under-surface loader of claim 1, wherein the parallel manipulator comprises a low-profile parallel manipulator.

7. The robotic under-surface loader of claim 6, wherein the low-profile parallel manipulator comprises a Tri-Sphere parallel manipulator.

8. The robotic under-surface loader of claim 1, wherein the cradle is tailored to carry the object.

9. The robotic under-surface loader of claim 1, further comprising:
a vertical lift.

10. The robotic under-surface loader of claim 9, wherein the vertical lift is carried by the mobility platform and carries the parallel manipulator and the cradle.

11. The robotic under surface loader of claim 9, wherein the vertical lift is carried by the parallel manipulator and the cradle is mounted atop the vertical lift.

12. The robotic under-surface loader of claim 9, wherein the vertical lift comprises a high-payload lift.

13. The robotic under-surface loader of claim 12, wherein the vertical lift comprises a scissor lift.

14. The robotic under-surface loader of claim 12, wherein the vertical lift comprises a hydraulic elevator.

15. A method for positioning an object beneath a structure, comprising:
placing the object on a cradle of a robotic under-surface loader;
moving the robotic under-surface loader into position beneath a downwardly facing surface of the structure;
with the object in position beneath the downwardly facing surface of the structure, using a parallel manipulator to position the object in a proper location and/or orientation relative to the downwardly facing surface; and
with the object in the proper orientation relative to the downwardly facing surface, securing the object in place relative to the downwardly facing surface.

16. The method of claim 15, further comprising:
lifting the object into proximity to the downwardly facing surface.

17. The method of claim 15, wherein using the parallel manipulator includes:
defining a first point in space around which the object is to be oriented;
with the first point in space defined, orienting the object around the first point in space;
with the object oriented around the first point in space, defining a second point in space around which the object is to be oriented; and
with the second point in space defined, orienting the object around the second point in space.

18. The method of claim 17, wherein securing the object in place comprises securing the object to a plurality of connection points.

19. The method of claim 17, wherein using the parallel manipulator comprises orienting the object in as many as six degrees-of-freedom.

20. The method of claim 15, wherein using the parallel manipulator comprises orienting the object in as many as six degrees-of-freedom.

21. The method of claim 15, wherein securing the object in place comprises attaching the object to at least one connection point on the downwardly facing surface.
